(19) United States
(12) Patent Application Publication
(10) Pub. No.: US 2010/0299679 A1
(43) Pub. Date: Nov. 25, 2010

(54) STORAGE DEVICE

(75) Inventors: XI WANG, Shenzhen City (CN); YI-FANG WU, Tu-Cheng (TW); YONG-HUI XIAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD, Shenzhen City (CN); HON HAI PRECISION INDUSTRY CO., LTD., Tu-Cheng (TW)

(21) Appl. No.: 12/548,109

(22) Filed: Aug. 26, 2009

(30) Foreign Application Priority Data
May 21, 2009 (CN) 200910302512.2

(51) Int. Cl. G06F 13/00

(52) U.S. Cl. 719/327

(57) ABSTRACT

A storage device includes a first storage unit and a second storage unit. The first storage unit stores a driver program and driver program information. The second storage unit includes a detection module, a comparing module, and a taking module. The detection module is capable of detecting information of a driver program in an electronic device. The comparing module is capable of comparing the electronic device driver program information with the first storage unit driver program information to determine which is older. The taking module is capable of taking the electronic device driver program from the first storage unit if the electronic device driver program information is newer than the first storage unit driver program information.

### BACKGROUND

1. Technical Field

The present disclosure relates to storage devices, and particularly to a storage device communicating with an electronic device through a connector.

2. Description of Related Art

A driver program is usually needed to operate hardware of a computer. The hardware may be, for example, a network card, a sound card, a graphics card, or other hardware. The driver program is usually stored in a disk. To install the driver program in the computer, the disk and a disk drive should be provided. There may be times later when it is desired to install the driver program on other computers, but if the disk has been lost or damaged it cannot be done.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a storage device in accordance with an embodiment.

FIG. 2 is a flow chart of using the storage device of FIG. 1 in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

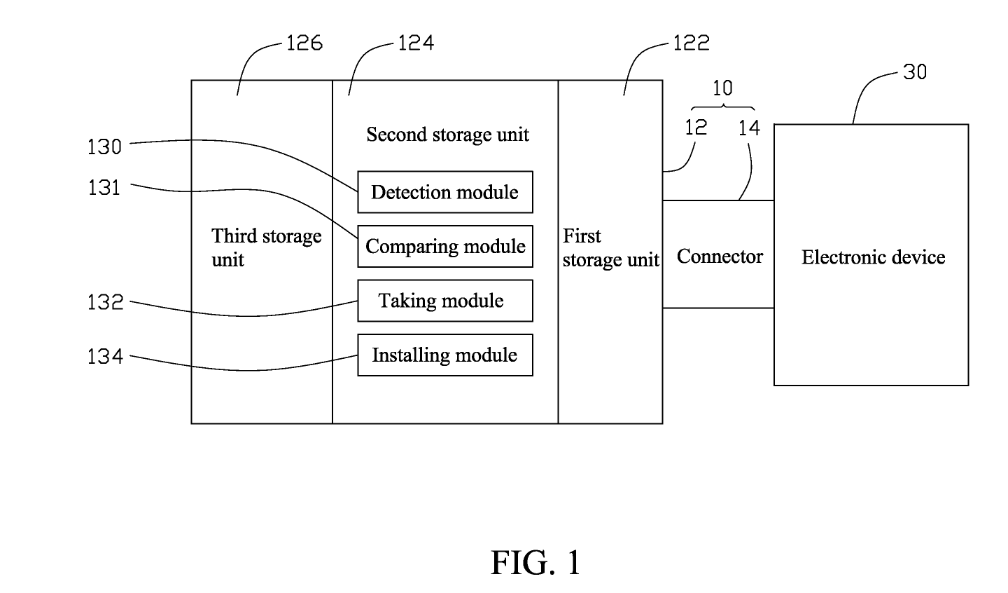

Referring to FIG. 1, a storage device 10 in accordance with an embodiment includes a base body 12 and a connector 14 located on the base body 12. The storage device 10 is capable of communicating with an electronic device 30 through the connector 14. The electronic device 30 may be, for example, a computer, a digital phone frame, a smart phone, or other electronic device.

The base body 12 includes a first storage unit 122, a second storage unit 124, a third storage unit 126. The first storage unit 122 stores a driver program of a hardware located in the electronic device and the driver program information. The driver program is capable of making the hardware perform its function when installed in the electronic device. The hardware may be, for example, a network card, a sound card, a graphics card, or other hardware. The driver program information includes versions and published dates of the versions.

The second storage unit 124 includes a detection module 130, a comparing module 131, a taking module 132, and an installing module 134. The detection module 130 is capable of detecting whether there is a hardware located in the electronic device 30 and compatible with the driver program of the first storage device 122 and whether there is a driver program of the hardware installed in the electronic device 30. Furthermore, the detection module 130 is capable of detecting the driver program's information when the driver program is detected. The comparing module 131 is capable of comparing the electronic device driver program information with the driver program information in the first storage unit 122, and determining which of the electronic device driver program and the first storage unit driver program is newer. For example, in order to determine which of the electronic device driver program and the first storage unit driver program is newer, the comparing module 131 can judge whose published dates of the compared driver programs is newer; or transform version numbers of the compared driver programs into binary system data or decimal system data or hex data respectively, and then judge which of the corresponding data is greater, etc. The taking module 132 is capable of taking the driver program from the electronic device 30 and storing the taken driver program in the first storage unit 122. The installing module 134 is capable of installing a driver program stored in the first storage unit 122 in the electronic device 30.

The third storage unit 126 is used to store information of the storage device 10, which includes property and security information.

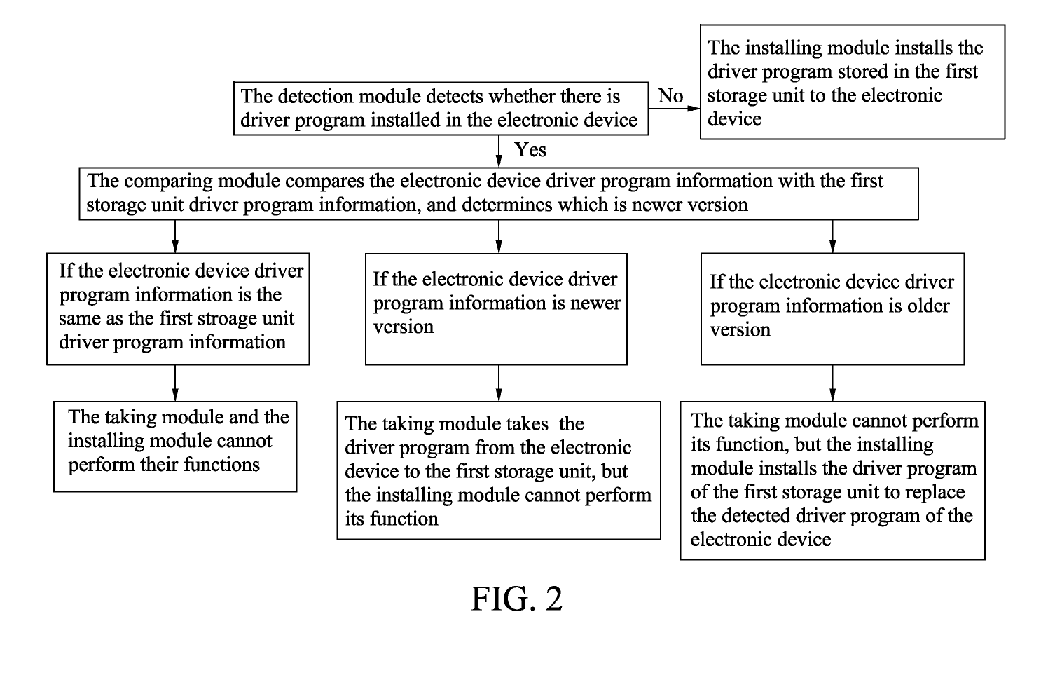

Referring also to FIG. 2, in use, the storage device 10 communicates with the electronic device 30 through the connector 14. The detection module 130 detects whether there is driver program installed in the electronic device 30. If no driver program is detected, the installing module 134 installs the driver program stored in the first storage unit 122 in the electronic device 30. If a driver program is detected, the comparing module 131 compares the electronic device driver program information with the driver program information stored in the first storage unit 122 and determines which of the electronic device driver program and the first storage unit driver program is newer. If the electronic device driver program information is the same as the driver program information in the first storage unit 122, the taking module 132 does not act. If the electronic device driver program information indicates a newer version, the taking module 132 takes the driver program from the electronic device 30 and stores in the first storage unit 122, but the installing module 134 does not perform its function. If the electronic device driver program information indicates an older version than the driver program information in the first storage unit 122, the taking module 132 does not perform its function, but the installing module 134 installs the driver program of the first storage unit to replace the electronic device driver program of the electronic device 30.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A storage device comprising:
a first storage unit storing a driver program and driver program information;
a second storage unit comprising a detection module, a comparing module, and a taking module; wherein the detection module is capable of detecting information of a driver program in an electronic device, the comparing module is capable of comparing the electronic device driver program information with the first storage unit driver program information to determine which is older, the taking module is capable of taking the electronic device driver program from the first storage unit if the electronic device driver program information is newer than the first storage unit driver program information.

2. The storage device of claim 1, wherein the storage device further comprises a connector through which the storage device is capable of communicating the electronic device.

3. The storage device of claim 1, wherein the storage device further comprises a third storage unit, the third storage unit storing property and security information of the storage device.

4. The storage device of claim 1, wherein the taking module is not capable of taking the electronic device driver program from the electronic device to the first storage unit if the electronic device driver program information is older than the first storage unit driver program information.

5. The storage device of claim 1, wherein the second storage unit further comprises an installing module; the installing module is capable of installing the first storage unit driver program to the electronic device to replace the electronic device driver program if the electronic device driver program information is older than the first storage unit driver program information.

6. The storage device of claim 5, wherein if the electronic device driver program information is newer than the first storage unit driver program information, the installing module is not capable of installing the first storage unit driver program to the electronic device to replace the electronic device driver program.

7. The storage device of claim 1, wherein the driver program information comprises of versions, publishing date or combinations thereof of the driver program.

8. A storage device storing a driver program and driver program information, the storage device comprising:
a detection module capable of detecting whether there is a driver program information located on an electronic device;
a comparing module capable of comparing the detected electronic device driver program information with the storage device driver program information to determine which is older; and
a taking module capable of taking the electronic device driver program from the electronic device if the electronic device driver program information is newer.

9. The storage device of claim 8, wherein the storage device further comprises a connector through which the storage device is capable of communicating the electronic device.

10. The storage device of claim 8, wherein the storage device further stores property and security information of the storage device.

11. The storage device of claim 8, wherein if the electronic device driver program information is older than the first storage unit driver program information, the taking module is not capable of taking the driver program in the electronic device to the first storage unit.

12. The storage device of claim 8, wherein the storage device further comprises an installing module; the installing module is capable of installing the first storage unit driver program onto the electronic device if the electronic device driver program information is older than the first storage unit driver program information.

13. The storage device of claim 12, wherein if the electronic device driver program information is newer than the first storage unit driver program information, the installing module is not capable of installing the first storage unit driver program to the electronic device to replace the electronic device driver program.

14. The storage device of claim 8, wherein the driver program information comprises version, publishing date, or combinations thereof of the driver program.
